(19) United States
(12) Patent Application Publication
(10) Pub. No.: US 2013/0118421 A1
(43) Pub. Date: May 16, 2013

(54) METHOD FOR PROTECTING HEAT EXCHANGER PIPES IN STEAM BOILER SYSTEMS, MOULDED BODY, HEAT EXCHANGER PIPE AND STEAM BOILER SYSTEM

(71) Applicants: Johannes Martin, Muenchen (DE); Toralf Weber, Emmering (DE); Thomas Putz, Westendorf (DE); Andreas Kienzle, Moettingen (DE)

(72) Inventors: Johannes Martin, Muenchen (DE); Toralf Weber, Emmering (DE); Thomas Putz, Westendorf (DE); Andreas Kienzle, Moettingen (DE)

(73) Assignees: SGL CARBON SE, Wiesbaden (DE); MARTIN GMBH FUER UMWELT- UND ENERGIETECHNIK, Muenchen (DE)

(21) Appl. No.: 13/811,435

(22) PCT Filed: Jul. 8, 2011
(86) PCT No.: PCT/DE2011/001435

§ 371 Date: Jan. 22, 2013

(30) Foreign Application Priority Data
Jul. 28, 2010 (DE) 10 2010 032 612.7

(51) Int. Cl. F22B 37/10; F28F 1/00; F16L 9/14

(52) U.S. Cl. CPC F22B 37/108; F16L 9/14; F28F 1/003
USPC 122/235.14; 29/455.1; 165/180; 428/34.5

(57) ABSTRACT

In order to protect heat exchanger pipes (1) in steam boiler systems, special casing elements (2) made of fiber-reinforced ceramic are proposed. The casing elements prevent or reduce the formation of films and corrosion on the heat exchanger pipes and thus enable higher steam parameters of the boiler system and a correspondingly increased thermal efficiency.

The invention relates to a method for protecting heat exchanger pipes in steam boiler systems and a moulded body for performing the method. Furthermore, the invention relates to a heat exchanger pipe and a steam boiler system with such a heat exchanger pipe.

Incineration furnaces for the combustion of combustible solids such as refuse and biomass incineration plants comprise a steam boiler with heat exchanger pipes. These heat exchanger pipes are used partly to evaporate water and partly to superheat evaporated water.

The problem with such plants is that the heat exchanger pipes corrode during the operation. Numerous investigations have shown that this corrosion is induced by adhering films of ash and salt. The gaseous waste gas components, such as for example HCl and SO₂, influence the composition of the films, but do not lead directly to corrosion attacks on these components.

In the extreme case, corrosion rates of up to 1 millimetre per 1000 hours can occur in refuse and biomass incineration plants.

Ceramic linings and metallic coatings are used as corrosion protection measures. Ceramic linings are either applied in mortar-like form onto the pipes, where they harden by so-called dry heating before the actual operation, or as baked shaped bricks which surround the parts of the pipes that are exposed to the corrosion attack. The metallic coatings are applied either by deposition welding or thermal spraying.

DE 38 23 439 C2 describes a ceramic, ready-sintered protective element comprising half-shells interlocking with one another. These shells, preferably produced from silicon carbide, have not proved successful in practice, since the required material has to be constituted relatively thick and heavy in order to withstand the load during the operation of the boiler system. In addition, the protective element has to be back-filled with a relatively large amount of mortar. Since the interlocking does not permit any thermal expansion, crack formation right up to bursting of the shells occurs at the high temperatures present during normal operation.

A further ceramic protective casing comprising overlapping half-shells made of silicon carbide is described in DE 20 2008 006 044 U1.

Ceramic linings on the walls have been thoroughly tried and tested in the combustion chamber, whereas the use of ceramic protective shells is not practicable in the superheater region. Apart from the static loading of the steel construction due to the weight of the protective shells, the heat exchanger pipes in the superheater region are subject to mechanical loads during cleaning.

Knocking arrangements, which act mechanically on the pipes in the superheater region in order to remove the films, find widespread use. Attempts are also made to remove the films with water or vapour bubbles, as a result of which additional chemical loads arise. These loads greatly limit the possible uses of ceramic linings for corrosion protection measures in the superheater region.

Deposition welding has proved to be an effective corrosion protection in the radiation passes. The material 2.4858 (Inconel 625) has become established as a weld material.

Material temperatures above 400° C., such as occur in the superheater region and—in the presence of very high operating pressures—in the evaporator pipes, have however a marked effect in reducing the corrosion protection of this material. Experience shows that the use of other filler materials, such as for example 2.4606 (Inconel 686), also brings no significant improvement.

Apart from that, thermal spraying processes are being used increasingly frequently as a corrosion protection measure. Trials with different material compositions as a corrosion protection layer on the boiler components have shown that such protection layers can fail unpredictably within a short time. The long-term corrosion protection cannot therefore be guaranteed with such methods.

The corrosion protection of boiler pipes on the one hand has an effect on the efficiency of the steam generator, since the deposited films can impair the heat transfer. On the other hand, most refuse and biomass incineration plants are operated only with steam temperatures of up to 400° C. with at most 40 bar steam pressure, in order to keep the corrosion within controllable limits. An increase of the steam parameters is associated with markedly increasing corrosion rates on the pressure chamber and therefore a reduction in the availability of the system. The known corrosion protection measures have not been able to provide satisfactory improvements here.

The problem underlying the invention, therefore, is to reduce the corrosion on heat exchanger pipes in steam boiler systems, with the simultaneous minimisation of the described drawbacks.

This problem is solved with the method for protecting heat exchanger pipes in steam boiler systems, wherein heat exchanger pipes of the steam boiler system are surrounded at least partially with fibre-reinforced ceramic.

The invention is based on the knowledge that the corrosion arising from heat exchanger pipes in steam boiler systems is induced by the adhering films. Experience has shown that the removal of the films, which represent a mixture of salts and ashes, from the pipe surface leads to a marked reduction, or even to a standstill, of the corrosion processes.

The films can be kept away from the heat exchanger pipes of the steam boiler system by the fact that the heat exchanger pipes are surrounded at least partially by fibre-reinforced ceramic.

It has emerged that fibre-reinforced ceramic can be used to reduce the formation of films on the heat exchanger pipes even in the presence of the high temperatures in the superheater region and the great mechanical loads of the cleaning systems. Fibre-reinforced ceramic can withstand high temperatures undamaged and it has a good capacity for resistance to water vapour-containing atmospheres. Moreover, the material has good conductivity and low thermal expansion.

The use of fibre-reinforced ceramic to protect the heat exchanger pipes enables the operation of the boiler system at much higher temperatures, as a result of which the thermal efficiency of the system can be considerably improved.

In order to avoid stresses between the ceramic casing and the steel of a heat exchanger pipe, it is proposed that the ceramic is disposed so as to be displaceable relative to the pipe. For this purpose, ceramic pipes or sleeves can be pushed onto the pipes before the heat exchanger pipes are assembled. The effect of this is that the ceramic is disposed in the form of a plurality of casing elements lying adjacent to one another.

Especially when the ceramic is to be applied on assembled heat exchangers, threading of ceramic rings or sleeves onto the heat exchanger pipe is no longer possible without damage it. It is therefore proposed that the casing elements are formed from circular-segment shells. For example, two circular-segment shells can be placed together to form a sleeve. Such a sleeve can subsequently be fitted on a pipe by the sleeve halves being placed on the pipe from opposite sides.

The sleeve halves can then be connected to one another or locked into one another. It is advantageous if the circular-segment shells are connected to one another axially and/or radially in a form-fit manner. A Z-joint can be formed, for example by undercuts or steps. Two opposite semicircular shells can engage into one another and be connected to one another in such a way that a particle access to the heat exchanger pipe is also prevented at the connection point.

Casing elements lying axially adjacent to one another can however also comprise undercuts or steps engaging into one another, in order to limit, for example by means of a Z-joint, the access of particles between the two casing elements to the heat exchanger pipe.

The casing elements can be fixed in their length by brackets, pipe bends and/or by weld points on the heat exchanger pipes.

The fibre-reinforced ceramic can comprise the most diverse additives to improve the stability and the surface properties. It is advantageous if the ceramic comprises carbon fibres. Carbon fibres are difficultly flammable and enable a particular stability of the ceramic, which is very important especially with regard to the mechanical knock-cleaning methods.

In order to keep the cost for corrosion protection low and to influence the heat transfer as little as possible, it is proposed that the ceramic has a thickness between the internal diameter and external diameter of less than 10 millimetres and preferably less than 5 millimetres.

The fibre-reinforced ceramic can also be applied as a coating directly on the pipes in order to keep the thickness of the material as small as possible and to enable expansion of the ceramic material together with the pipes. Insofar as the ceramic material is rigidly connected to the pipe, even crack formations in the ceramic material can be accepted, since they impair the function of the lining only slightly.

The pipes can also be surrounded with fibre materials, such as fibre ceramic mats for example. The ceramic can be formed before the application on the pipe, after the application on the pipe in a furnace or even during the heating of the material after the start-up of the boiler in the incineration plant.

For this purpose, the boiler pipes can be wrapped or surrounded with the material. In this regard, a material in the form of mats, woven fabric and/or in a kind of chain mail is suitable. These materials either comprise already fibre-reinforced ceramic or the ceramic is formed only after the application on the pipe by sintering, curing or similar processes.

Tests have shown that it is thus possible for the ceramic to be subjected to temperatures of over 400° C.

Correspondingly, the heat exchanger pipes can be exposed at their inner side to a pressure of over 40 bar.

The metal pipe and the ceramic can also be rigidly connected to one another by, for example, producing a ceramic compound pipe.

In order that the casing elements are suitable for use on heat exchanger pipes of industrial incineration furnaces, it is proposed that the ceramic has an internal diameter of more than 30 mm, preferably approx. 40 to 60 mm.

The subject-matter of the invention is also a moulded body with a fibre-reinforced ceramic for performing the method, which is suitable for encasing a heat exchanger pipe. Furthermore, the subject-matter of the invention is a heat exchanger pipe which is surrounded by such a moulded body. A preferably annular gap can be disposed between the moulded body and the heat exchanger pipe. Finally, the invention relates to a steam boiler system with such a heat exchanger pipe.

The invention is explained in greater detail below with the aid of an example of embodiment.

The single FIGURE shows a view of a heat exchanger pipe with a casing element.

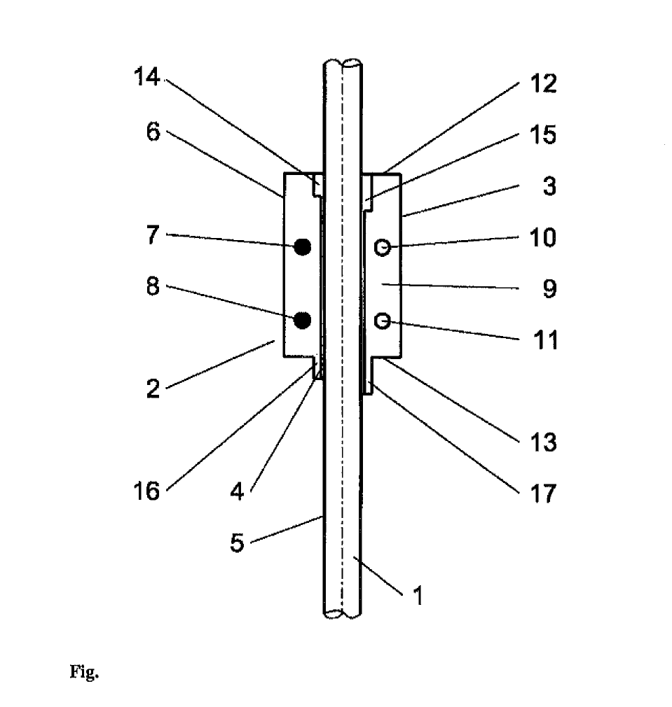

Heat exchanger pipe 1 shown in FIG. 1 is one pipe of many heat exchanger pipes of a heat exchanger (not shown) of a steam boiler system (not shown). This heat exchanger pipe 1 is surrounded by a plurality of casing elements 2. Of these casing elements 2, only circular-segment shell 3 of a casing element is shown. This circular-segment shell 3 has an inner side 4, which lies adjacent to outer side 5 of heat exchanger pipe 1.

At a distance of, for example, 5 millimetres from inner side 4, circular-segment shell 3 has an outer side 6, which is designed particularly smooth to prevent deposits.

A structure for influencing the flow, such as for example a corrugated structure or flow pegs, can be provided on outer side 6 in order to improve the heat transfer by turbulence or solely by the surface enlargement. The separating behaviour at the surface of the casing elements can also be favourably influenced by means of a suitable structure. Whilst the microscopic structure of outer side 6 of circular-segment shell 3 should be as smooth as possible to avoid deposits, the macroscopic structure can comprise undulations, for example, on a smooth surface.

A variant of embodiment makes provision such that a very smooth coating of the ceramic surface is achieved, for example by means of nanoparticles, in order to minimise the caking of particles such as dust from the flue gas.

Circular-segment shell 3 comprises peg-shaped projecting elements 7, 8, which interact with corresponding recesses in an opposite-lying circular-segment shell, in order to enable a form-fit and, if need be, also a friction-locked matching connection between two circular-segment shells lying radially opposite one another.

Circular-segment shell 3 has on its other end face 9 two blind-holes 10, 11, which can interact with pegs of an opposite circular-segment shell (not shown). Pegs and holes can be provided at an angle of, for example, approx. 45° C. This leads to positioning of the shells relative to one another and to adequate fixing of the shells to one another.

A symmetrical embodiment of the circular-segment shells makes it possible to use these moulded parts for two opposite circular-segment shells capable of being connected in a form-fit manner.

The embodiment of circular-segment shell 3 also enables a form-fit connection between two circular-segment shells lying axially adjacent to one another.

In this regard, a step 14, 15 and respectively 16, 17 is provided in each case on axially opposite end faces 12, 13, said step making it possible to push axially projecting element 16, 17 into recess 14, 15 in the adjacent circular-segment shell.

The form shown is only an example of embodiment that illustrates the basic structure of a casing element. It can easily be seen by the person skilled in the art that there are various other possible ways of forming casing elements within the scope of the invention, which preferably interact with one another in a form-fit manner, radially and if appropriate also axially. Good protection of heat exchanger pipe 1 is thus achieved.

The match between heat exchanger pipe 1 and casing element 2 is selected such that the expansion of heat exchanger pipe 1 relative to casing element 2 does not lead to destruction of casing element 2, and on the other hand the distance between inner surface 4 of casing element 3 and outer surface 5 of heat exchanger pipe 1 is selected at a minimum. The effect of this is that the heat exchanger pipe lies firmly adjacent to the fibre-reinforced ceramic at the operating temperature, but without exerting excessively high pressure on the latter.

A material having a positive effect on the heat transfer can be introduced in the gap that remains between inner surface 4 of casing element 3 and outer surface 5 of the heat exchanger pipe.

The gap can also be dimensioned such that the fibre-reinforced ceramic can be pulled easily over the heat exchanger pipe and the inner face of the ceramic is coated such that the latter foams up when a specific temperature is reached in order to fill the intermediate space. Special materials that foam up under the effect of heat are known in this regard.

When the casing elements are installed, a material can also be applied on the boiler pipes, which disappears (e.g. evaporates) during the first start-up and thus leaves the gap for the thermal expansion.

In order to enable expansion of the casing element when heat exchanger pipe 1 expands, casing element 2 can also comprise a plurality of casing elements radially fitted together and axially separated.

In particular, a stepped end face of circular-segment shells of a casing element enables a certain radial expansion of a casing element when the heat exchanger pipe undergoes thermal expansion, without particles finding direct access to the heat exchanger pipe.

By means of special undercuts, casing element parts, such as circular-segment shells, can be radially suspended into one another and/or axially suspended on one another, so that a heat exchanger pipe can be surrounded by casing elements without screwing solely by plug-in connections.

It goes without saying that, in regions in which a heat exchanger pipe is constituted as a pipe bend, the casing elements must also be constituted so as to be correspondingly matched.

A variant for producing an encased pipe of the method according to the invention is explained below by way of example.

In a first step, fibre bundles are produced which do not react in the subsequent silicisation process. Carbon-fibre strands comprising in each case 50,000 virtually parallel individual filaments are impregnated with phenolic resin, so that a prepreg with a mass-related resin content of 35% and a weight per unit area of 320 g/m² arises. This prepreg is continuously compacted at a rate of 1 m/min at a pressure of 1 MPa on a belt press at a temperature of 180° C. to form a fabric web with a thickness of 200 μm and is at the same time hardened to an extent such that a dimensionally stable fabric web is obtained. The fabric web is then split up into individual strips with a width of 50 mm in each case. As described above, the latter are cut into segments with a length of 9.4 mm and a width of 1 mm. 2400 g of the fibre bundles is transferred into a tumble dryer and covered by pouring with 600 g of powdered resin and the latter are mixed with one another for 5 minutes.

The pressing tool is filled with the moulding compound. In order to achieve a preferentially tangential orientation of the fibre bundles, a filling grid is used which comprises a plurality of rings, the spacing whereof is less than or equal to the length of the fibre bundles. During the filling, the moulding compound falls with the fibre bundles through the intermediate spaces between the concentric rings of the filling grid, and the fibre bundles assume an essentially tangential arrangement. The filled pressing tool is exposed on a hot flow press for 30 minutes to a pressure of 4.0 N/mm² and a temperature of 160° C. and is then demoulded. The phenolic resin cures during the pressing process. A green body close to its final contour is obtained in the form of an annular disc, the internal diameter whereof corresponds to that of the pipe subsequently to be protected. Of these discs, 10 units are coated with a phenolic resin adhesive containing SiC powder and clamped in a clamping device in such a way that the individual discs lie precisely one above the other and the joint gap is less than 0.5 mm. The clamped discs are transferred with a clamping device into a drying cabinet and cured at about 180° C. for 30 min. The emerging cylinder, called a green body, is then removed from the clamping device and carbonised.

The green body is heated in a protective gas oven under a nitrogen atmosphere at a heating rate of 1 K/min to a temperature of 900° C. The phenolic resins are thereby decomposed to form a residue essentially comprising carbon. This temperature is maintained for an hour. The carbonised moulded body is then cooled to room temperature. The emerging porous CFC cylinder is then transferred into a crucible made of graphite and covered by pouring with silicon and is heated in an oven under vacuum to temperatures of 1700° C. From a temperature of 1420° C., liquid silicon enters into the porous preform and converts the matrix carbon into silicon carbide. The moulded C/SiC pipe is then ground in the external and internal region to the desired final geometry.

The C/SiC moulded body thus produced has a strength of 50-300 MPa and a thermal conductivity of 50-150 W/mK. The material composition of the moulded body can be specified as follows depending on the production process: 2-30% carbon, 50-70% silicon carbide and 5-15% silicon. The porosity of the material is very low at <2%.

1. A method for protecting heat exchanger pipes in steam boiler systems, wherein heat exchanger pipes of the steam boiler system are surrounded at least partially with ceramic.

2. The method according to claim 1, wherein the ceramic is fiber-reinforced.

3. The method according to claim 1, wherein the ceramic is formed at least partially from silicon carbide.

4. The method according to claim 3, wherein the ceramic is formed at least partially by silicization of a graphite film or carbon film, especially a film made of expanded graphite.

5. The method according to claim 1, wherein the ceramic is disposed so as to be displaceable relative to the heat exchanger pipe (1).

6. The method according to claim 1, wherein the ceramic is disposed in the form of a plurality of casing elements lying adjacent to one another.

7. The method according to claim 1, wherein the casing elements are formed by circular-segment shells.

8. The method according to claim 4, wherein the circular-segment shells are connected to one another axially and/or radially in a form-fit manner.

9. The method according to claim 1, wherein the ceramic comprises carbon fibers.

10. The method according to claim 1, wherein the ceramic is exposed to temperatures of over 400° C.

11. The method according to claim 1, wherein the heat exchanger pipes are exposed at their inner side to a pressure of over 40 bar.

12. The method according to claim 1, wherein the ceramic has a thickness between the internal diameter and external diameter of less than 10 millimeters and preferably less than 5 millimeters.

13. The method according to claim 1, wherein the ceramic has an internal diameter of more than 30 mm.

14. The method according to claim 1, wherein the surface of the ceramic comprises structures for influencing the flow and for influencing the separating behavior of particles.

15. The method according to claim 1, wherein the casing elements are fixed in their length by means of brackets or weld points.

16. A molded body with a fiber-reinforced ceramic for performing a method according to claim 1, which is suitable for encasing a heat exchanger pipe.

17. The molded body according to claim 1, the surface whereof is coated with nanoparticles to prevent deposits or caking.

18. A heat exchanger pipe which is surrounded by a molded body according to claim 9.

19. The heat exchanger pipe according to claim 18, wherein a preferably annular gap is disposed between the molded body and the heat exchanger pipe.

20. A heat exchanger pipe which is surrounded by fiber materials such as for example fiber-ceramic mats.

21. A steam boiler system which comprises heat exchanger pipes according to claim 18.
